(19) United States
(12) Patent Application Publication
(10) Pub. No.: US 2004/0212703 A1
(43) Pub. Date: Oct. 28, 2004

(54) Image sensing apparatus

(75) Inventors: Kunihiko Sugimoto, Sakai-Shi (JP); Hiroaki Kubo, Muko-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/632,078

(22) Filed: Jul. 31, 2003

(30) Foreign Application Priority Data
Apr. 25, 2003 (JP) 2003-121516

(51) Int. Cl. H04N 5/217

(52) U.S. Cl. 348/241

(57) ABSTRACT

An image sensing apparatus is provided with an image sensor, a first storage section for storing image data from the image sensor owing to an exposure to an object for an exposure time, a second storage section for storing noise data from the image sensor without exposure for a time substantially equal to the exposure time in the first photographing operation, a multiple reference value storing section for storing multiple reference values for modifying noise data, a reference value selecting section for comparing noise data with multiple reference values, and selecting a reference value among the multiple reference values most approximate to the noise data, a data modifying section for modifying the noise data in accordance with the selected reference value, and a subtracting section for subtracting the modified noise data from the image data stored in the first storage section.

This application is based on Japanese patent application No. 2003-121516 filed on Apr. 25, 2003, the contents of which are hereby incorporated by references.

### BACKGROUND OF THE INVENTION

1. Field of the Invention

This invention relates to an image sensing apparatus, and more particularly to an image sensing apparatus for use in a digital camera which can remove noise components generated during photographing, in particular during a long time photographing.

2. Description of the Related Art

There has been known a charge-coupled device (CCD) sensor as an example of image sensors for use in digital cameras. Generally, image data obtained by sensing an image with use of a CCD sensor contains various noises such as dark current noises resulting from dark currents, random noises from connected devices, fixed pattern noises (hereinafter called as “FPNs”) which inevitably occur in each pixel of the CCD sensor. These noises cause deterioration of a resultant photographic image. Particularly, these noises easily increase with rises in the heat and the ISO speed of a programmable gain amplifier (PGA).

FIGS. 12A through 12C are illustrations for explaining noises contained in image data. FIG. 12A is an illustration showing image data sensed by a CCD sensor containing noise data. FIG. 12B is an illustration showing image data which has been amplified by a PGA containing amplified noise data. FIG. 12C is an illustration showing different noise components contained in noise data. Image data (hereinafter, called as “image data G”) and noise data (hereinafter, called as “noise data N”) in FIGS. 12B and 12C are expressed as an electric current value I flowing through pixels of a CCD sensor and outputted in time-series by horizontal scanning of the CCD sensor. In FIGS. 12A, 12B, and 12C, the axis of ordinate represents electric current value I, and the axis of abscissas represents time t.

As shown in FIG. 12A, noise data N is contained in image data G when an object image is sensed with a CCD sensor. Accordingly, if such image data G containing noise data D is displayed as a photographic image without implementing a processing of removing noise data D, flaws representing unprocessed noises appear in the photographic image. Further, as shown in FIG. 12B, if image data outputted from a CCD sensor is amplified by a PGA, noise data D is also amplified along with the image data G, thereby further deteriorating quality of a resultant photographic image. In addition to the above, as shown in FIG. 12C, noise data D includes various noise components such as noises having a relatively large peak which occurs when the CCD sensor is heated, random noises, and FPNs having a relatively small peak.

Image quality deterioration is remarkable especially when the shutter speed of a camera is shifted to a larger value. In recent years, digital cameras tend to have a low shutter speed thanks to downsizing of a CCD sensor, for example. It is conceived that this trend will continue, and therefore, there is a demand for a measure of preventing deterioration of photographic image quality due to noises.

As a way of removing dark current noises, Japanese Unexamined Patent Publication No. 8-37627 discloses an arrangement in which dark current noise data is obtained by operating a CCD sensor without exposure (namely, in a light blocking state) for a time duration generally equal to an exposure time corresponding to a shutter speed designated when actually sensing an object image with exposure, and the dark current noise data is subtracted from image data obtained by actually sensing the object image with exposure to remove the dark current noise component.

FIG. 13 is an illustration for explaining the conventional way of removing dark current noise data. As shown in FIG. 13, according to the conventional way, a subtractor 207 subtracts dark current noise data obtained by operating a CCD sensor without exposure or in a light blocking state for a time duration substantially equal to an exposure time corresponding to a shutter speed designated in an actual image sensing operation with exposure, from image data obtained by the actual image sensing operation with exposure at the designated shutter speed to thereby obtain image data with the dark current noise component thereof being removed.

Despite the aforementioned way of removing dark current noise data, as shown in FIG. 12C, however, it should be noted that noise data usually includes random noises from processing devices when reading out image data from the CCD sensor, and FPNs of each pixels of the CCD sensor. The way of removing noises disclosed in the above publication is effective in removing noises having relatively large peaks which may likely to appear as a relatively large flaw in a photographic image, but is not effective in removing noises having relatively small peaks. However, other noises such as random noises are processed as error, resulting in further image deterioration.

### SUMMARY OF THE INVENTION

It is an object of the present invention to provide an image sensing apparatus, an exposure signal processing apparatus, and a noise data removal method which are free from the above problems residing in the prior art.

According to an aspect of the invention, there is provided an optical sensor for generating electric data in accordance with an exposure to light of an object for a specified exposure time. The optical sensor is operated without exposure for a time substantially equal to an exposure time to generate noise data. Multiple reference values for modifying noise data are stored in a storage, and a proper reference value is selected among the multiple reference values by comparing noise data with the multiple reference values. The noise data is modified in accordance with the selected reference value. The electric data is corrected based on the modified noise data. The corrected electric data can assure an image having an improved quality and a less noise influence.

These and other objects, features and advantages of the present invention will become more apparent upon a reading of the following detailed description and accompanying drawing.

### BRIEF DESCRIPTION OF THE DRAWINGS

FIG. 1 is a schematic diagram showing a sectional plan view of a digital camera incorporated with an image sensing apparatus in accordance with an embodiment of the invention;

FIG. 2 is a schematic diagram showing a right side view of the digital camera;

FIG. 3 is a schematic diagram showing a rear view of the digital camera;

FIG. 4 is a block diagram showing an electrical configuration of the digital camera;

FIG. 5 is a block diagram showing a construction of the image sensing apparatus in accordance with the embodiment;

FIG. 6 is an illustration showing an example of table data stored in a reference value storage section of the image sensing apparatus when a reference internal temperature of the digital camera is 20° C.;

FIGS. 7A through 7D are illustrations for explaining how multiple reference values are used in the image sensing apparatus;

FIG. 8 is a flowchart showing a noise data removal operation to be implemented by the image sensing apparatus;

FIG. 9 is an illustration showing a data conversion of noise data;

FIG. 10 is a flowchart showing a reference value group determination in Step ST4 of the flowchart shown in FIG. 8;

FIG. 11 is a block diagram showing a construction of an image sensing apparatus in accordance with another embodiment of the invention;

FIGS. 12A through 12C are illustrations showing noise data contained in image data; and

FIG. 13 is an illustration showing removal of dark current noise data in the prior art.

### DETAILED DESCRIPTION OF THE PREFERRED EMBODIMENTS OF THE INVENTION

Preferred embodiments of the invention are described referring to the accompanying drawings. Note that elements identical to each other throughout the drawings are denoted at the same reference numerals to avoid repeated description on the identical elements.

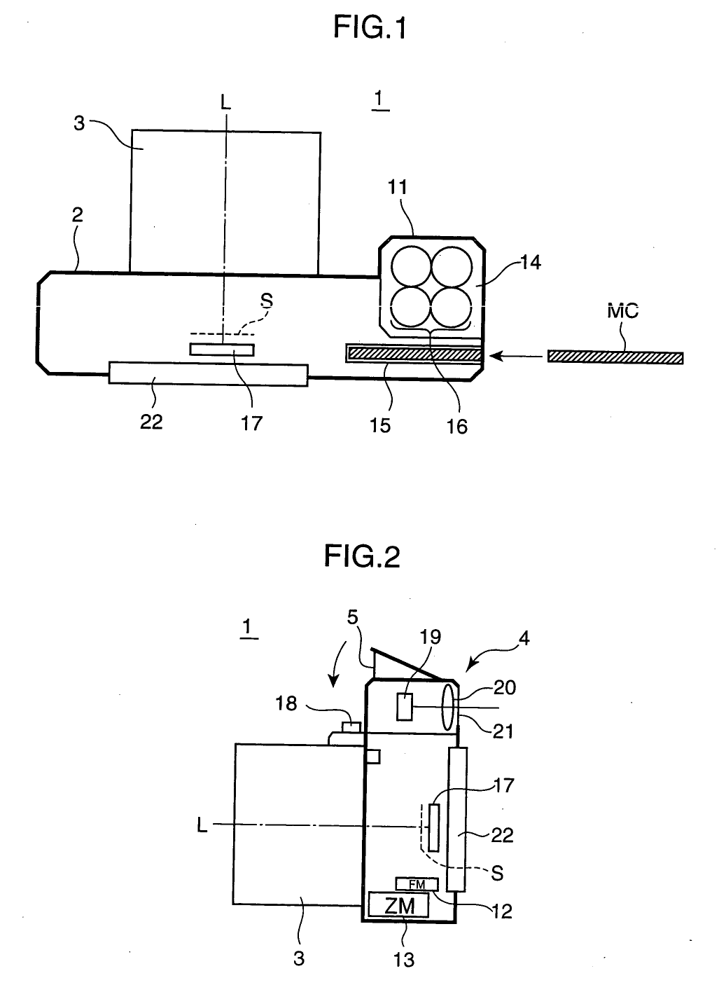

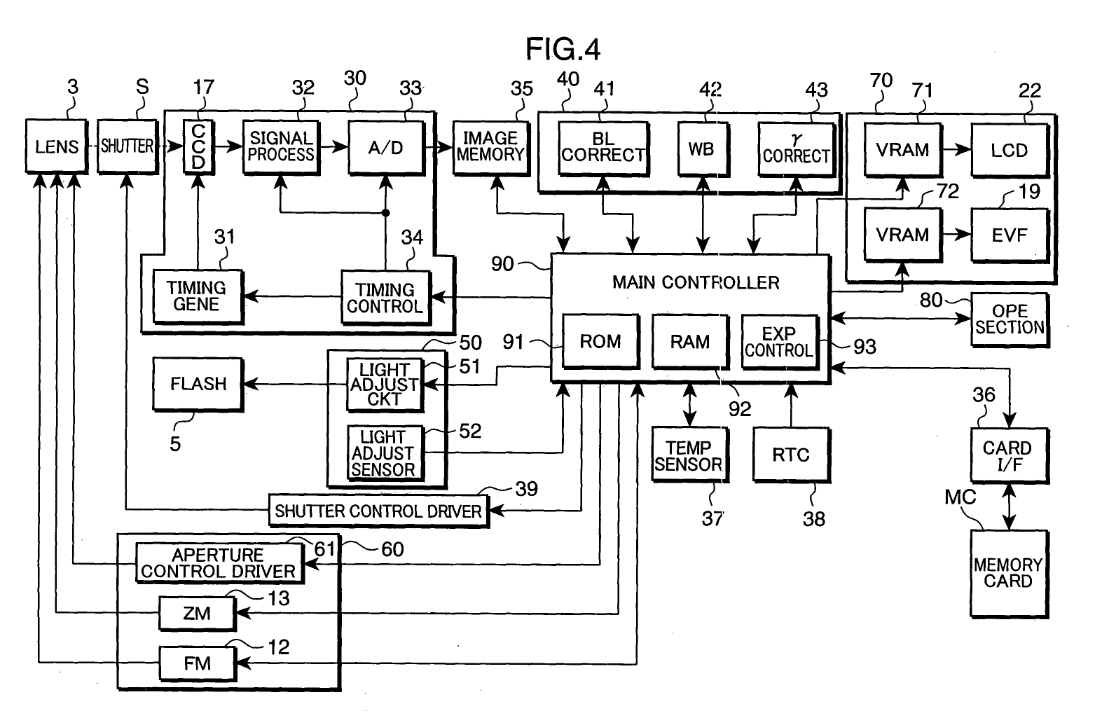

Referring to FIG. 1, a digital camera 1 is a single lens reflex camera having a main body 2 and a lens unit 3 which is detachably attached generally in a middle on the front face of the main body 2. As shown in FIG. 2, an electronic viewfinder 4 (called as “EVF 4” in FIG. 4) and a pop-up type flash 5 are provided on a top of the main body 2. In this embodiment, the digital camera 1 is explained as a single lens reflex camera having the lens unit 3 detachably attached to the main body 2. This invention is, however, not limited thereto. As an alternative, the digital camera may be of a compact type in which a lens unit 3 and a camera main body 2 are integrally formed.

Referring again to FIG. 1, the camera main body 2 has a mount portion (not shown) substantially in the middle on the front face thereof for mounting the lens unit 3, and a grip portion 11 at a left end portion of the camera main body 2 viewed from the front to be gripped by a user with his or her hand. A plurality of contacts (not shown) for electrical connection with the lens unit 3 and a plurality of couplers (not shown) for mechanical connection with the lens unit 3 are provided at a lower part of the mount portion.

The electrical contacts are adapted for transmitting information inherent to the lens unit 3 (such as full aperture F-number and focal distance) from a lens ROM provided in the lens unit 3 to a main controller 90 (see FIG. 4), as well as transmitting information concerning positions of a focus lens and a zoom lens in the lens unit 3 to the main controller 90 (see FIG. 4).

The couplers are adapted for transmitting a driving force of a focus motor 12 for driving the focus lens (denoted at “FM 12” in FIG. 4) and a driving force of a zoom motor 13 for driving the zoom lens (denoted at “ZM 13” in FIG. 4) both of which are provided in the main body 2 to the respective lenses (focus lens and zoom lens) in the lens unit 3.

Referring to FIG. 1, a battery housing chamber 14 and a card housing chamber 15 are formed in the grip portion 11. The battery housing chamber 14 has such dimensions as to accommodate, for example, four AA-size batteries 16 therein as a power source for the camera 1. The card housing chamber 15 has such dimensions as to accommodate a memory card MC for recording image data concerning photographic images therein.

A color image sensor 17 is arranged at an appropriate position in the camera main body 2, namely, at an appropriate position on an optical axis L of the lens unit 3 when the lens unit 3 is mounted on the mount portion.

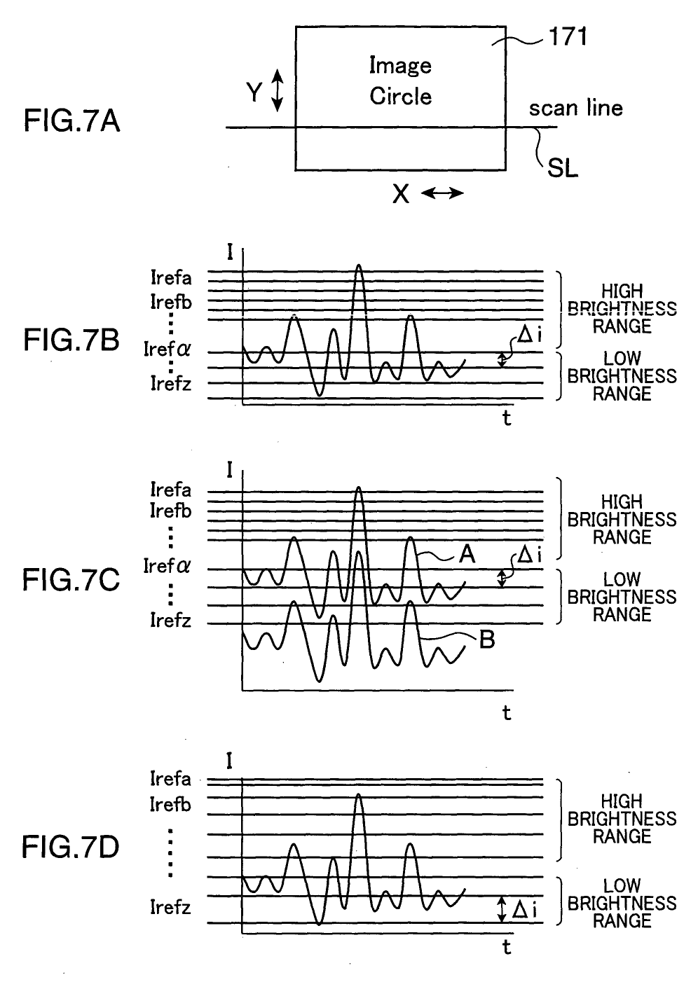

The color image sensor 17 (hereinafter, called as “CCD sensor”) is a single CCD color area sensor of the so-called “Bayer matrix” in which color filters each in red (R), green (G), and blue (B) are attached in a matrix manner on respective surfaces of charge coupled devices (CCDs) arrayed in two dimensions. In this embodiment, the CCD sensor 17 has charge coupled devices in the number of 1,600 in horizontal direction (directions of arrows X in FIG. 7A) and 1,200 in vertical direction (directions of arrows Y in FIG. 7A), namely 1,920,000 charge coupled devices in total. Hereinafter, respective CCDs are also called as pixels.

A mechanical shutter S such as a focal plane shutter is provided in front of the CCD sensor 17 to mechanically move the curtain of the shutter. The shutter S is opened and closed by a shutter control driver 39 (see FIG. 4). As the shutter S is opened in response to a control operation by the shutter control driver 39, the front face of the CCD sensor 17 is supplied with an optical energy necessary for photographing, and as the shutter S is closed, the CCD sensor 17 is blocked from light. In this embodiment, the shutter speed is expressed in terms of an exposure time duration from an opened state of the shutter S to a closed state thereof.

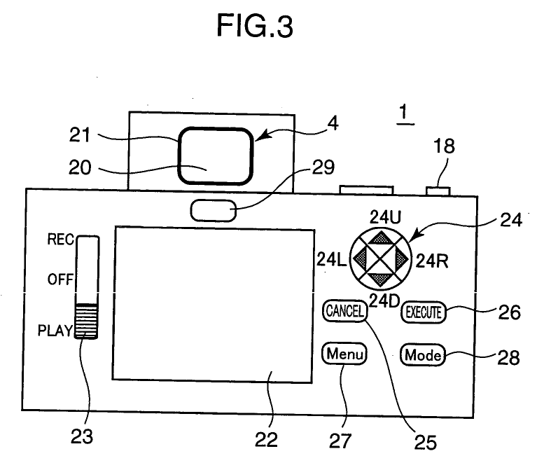

As shown in FIGS. 2 and 3, a shutter release button 18 is provided on the upper face of the grip portion 11 of the camera main body 2. The shutter release button 18 is selectively rendered to a halfway pressed state S1 where the shutter release button 18 is depressed halfway, and a fully pressed state S2 where the shutter release button 18 is depressed fully. When the shutter release button 18 is rendered to a halfway pressed state S1, executed is a photographing preparatory operation of photographing a still image (preparatory operation such as setting of exposure control value and focus adjustment). When the shutter release button 18 is rendered to a fully pressed state S2, executed is an actual photographing operation (a series of operations of exposing the CCD sensor 17, implementing a predetermined image processing with respect to image signals obtained by the exposure, and recording the processed image data in the memory card MC).

Referring to FIGS. 2 and 3, the electronic viewfinder 4 includes a viewfinder display section 19, an eyepiece lens 20, and a viewfinder window 21. The viewfinder display section 19 has a color liquid display device of 640 pixels (in X-direction) by 480 pixels (in Y-direction)=307,200 pixels in this embodiment. The viewfinder display section 19 displays an image of an object (monitor image) sensed by the CCD sensor 17, namely, a moving picture of the object image sensed by the CCD sensor 17 in a photography stand-by state where the shutter release button 18 is not operated. A monitor image displayed on the viewfinder display section 19 is guided outside the viewfinder window 21 by way of the eyepiece lens 20. With this arrangement, a photographer or user can recognize an object image to be photographed through a monitor image displayed on the viewfinder display section 19 by looking at the viewfinder window 21.

A monitor image displayed on the viewfinder display section 19 is used for allowing a user to recognize an object image through the viewfinder window 21. Accordingly, the CCD sensor 17 is operated in a different operation mode (hereinafter, called as “still picture sensing mode”) other than a normal operation of photographing a still image, in a photography stand-by state. Namely, in the still picture sensing mode, a monitor image having the same size as the display size on the viewfinder display section 19 is sensed by the CCD sensor 17. More specifically, since the display size on the viewfinder display section 19 is 640 pixels (in X-direction) by 480 pixels (in Y-direction) in this embodiment, although all the pixels of the CCD sensor 17 are activated for image exposure in a photography stand-by state, image data is read out every 8 pixels both in horizontal and vertical directions to thereby extract data of 640 pixels (H) by 480 pixels (V) corresponding to a monitor image at a high speed in the still picture sensing mode.

In FIG. 3, an external display section (liquid crystal display section) 22 is provided substantially in a middle on the rear face of the camera main body 2. The external display section 22 includes a color liquid display device of 400 pixels (in X-direction) by 300 pixels (in Y-direction)=120,000 pixels. The external display section 22 displays a menu screen on which a user is allowed to designate, for example, a mode concerning exposure control, a mode concerning photographic scenes, and various photographing conditions while the camera 1 is in recording (REC) mode, and reproduces and displays a photographic image or images recorded in the memory card MC thereon while the camera 1 is in reproducing (PLAY) mode.

A power switch 23 is provided at a left side relative to the external display section 22 in FIG. 3. The power switch 23 serves as a mode selecting switch for allowing a user to select the operation mode of the camera 1 between recording mode (mode having a function of photographing), and reproducing mode (mode having a function of reproducing a recorded image or images on the external display section 22) and sets the selected mode. Specifically, the power switch 23 includes a three-point-contact slide switch. When a user slides the power switch 23 to the middle position denoted at “OFF”, power of the camera 1 is turned off. When the user slides the power switch 23 to the upper position denoted at “REC”, power of the camera 1 is turned on and the camera 1 is switched to recording mode. When the user slides the power switch 23 to the lower position denoted at “PLAY”, power of the camera 1 is turned on and the camera 1 is switched to reproducing mode.

A four-way switch 24 is provided at an upper right position relative to the external display section 22. The four-way switch 24 has a circular-shaped operation section consisting of upward switch 24U, downward switch 24D, leftward switch 24L, and rightward switch 24R. When a user pressingly moves the four-way switch 24 in one of the four directions (upward, downward, leftward, and rightward directions), operation of the upward switch 24U (or downward switch 24D, leftward switch 24L, rightward switch 24R) is detected accordingly.

The four-way switch 24 has multi-functions. The switch 24 functions as an operation switch for allowing a user to change the photographic scene to a desired one on the menu screen displayed on the external display section 22. The switch 24 also functions as an operation switch for allowing a user to select and change a frame of an image to be reproduced on an index screen of the external display section 22 where a number of thumbnails are arrayed in a certain direction and displayed accordingly. The leftward switch 24L and the rightward switch 24R also function as zoom switches for allowing a user to change the focal distance of the zoom lens of the lens unit 3.

A cancellation switch (CANCEL) 25, an execution switch (EXECUTE) 26, a menu display switch 27, and a display change-over switch 28 are provided at a lower right position relative to the external display section 22 for allowing a user to display a desired item on the external display section 22 and perform a desired operation concerning the display contents.

The cancellation switch 25 is a switch used in canceling the selected content on the menu screen. The execution switch 26 is a switch used in executing the selected content on the menu screen. The menu display switch 27 is a switch used in displaying the menu screen on the external display section 22 and in changing the contents on the menu screen (e.g. a screen relating to photographic scene setting and a screen relating to mode setting concerning exposure control). Every time the menu display switch 27 is depressed, the contents on the menu screen are cyclically changed.

The display change-over switch 28 is a switch used in changing over display and non-display on the external display section 22. Every time the display change-over switch 28 is depressed, display and non-display on the external display section 22 are alternately activated. It should be noted that display on the external display section 22 is not executed during start-up operation of the camera 1 to save energy of the battery 16.

An eyepiece sensor 29 is provided at an appropriate position above the external display section 22 for detecting whether an eye of a user approaches the sensing region of the eyepiece sensor 29, namely, a contact state with the user. The eyepiece sensor 29 is comprised of a light emitting section (e.g. a light emitting diode) for emitting an infrared ray and a light receiving section (e.g. a photo reflector) for receiving reflected light from the light emitting section. As the face of the user approaches the camera 1 (light receiving section), the light receiving section receives reflected light which has been emitted from the light emitting section and reflected on the face of the user. The eyepiece sensor 29 recognizes a contact state with a user based on an output value which has been converted to an electrical signal by photoelectrical conversion of the optical energy of the reflected light, and outputs a detection signal indicating detection of the contact to the main controller 90 (see FIG. 4). In this embodiment, the eyepiece sensor 29 is provided on the upper region relative to the external display section 22. Alternatively, as far as the eyepiece sensor 29 can detect a contact state with the user, the eyepiece sensor 29 may be provided at any location such as at a left-side position or a right-side position relative to the external display section 22.

FIG. 4 is a block diagram showing an arrangement of the digital camera 1. Note that elements in FIG. 4 which are identical to those in FIGS. 1 to 3 are denoted at the same reference numerals. The digital camera 1 has the lens unit 3, an image sensing section 30, an image memory 35, a signal processing section 40, a flashlight controlling section 50, a lens controlling section 60, a display section 70, an operating section 80, and the main controller 90.

The lens unit 3 is provided with the lens ROM (not shown) in which information inherent to the lens unit 3 (such as full aperture F-number and focal distance) is stored, as well as a diaphragm for adjusting the focus lens, the zoom lens, and a light transmission amount of the lens unit 3. The lens ROM is electrically connected with the main controller 90 by an electrical contact.

The image sensing section 30 photoelectrically converts an optical energy from an object image through the lens unit 3 into an electrical image signal or exposure signal. The image sensing section 30 has the CCD sensor 17, a timing generator 31, a signal processing circuit (analog signal processing circuit) 32, an A/D converting circuit 33, and a timing controlling circuit 34.

The CCD sensor 17 receives the optical energy of the object image for a certain exposure time based on a drive control signal (charge accumulation start signal/end signal) outputted from the timing generator 31, converts the received optical energy to an image signal (charge accumulation signal), and transmits the image signal to the signal processing section 40 based on a read-out control signal (horizontal scanning signal, vertical scanning signal, transmitting signal, etc.) outputted from the timing generator 31. Note that the image signal is transmitted to the signal processing section 40 in a state that the image signal is separated into each color component of R, G, B.

Hereinafter, for sake of easy explanation, a light receiving signal of each pixel is referred to as a pixel signal (analog value) or pixel data (digital value) depending on a situation to differentiate the light receiving signal from an image signal composing a photographic image, which is a collection of the light receiving signals of the respective pixels of the CCD sensor 17.

The timing generator 31 generates a drive control signal based on a control signal outputted from the timing controlling circuit 34, generates a read-out control signal based on a reference clock signal, and transmits the respective control signals to the CCD sensor 17. The timing generator 31 generates, for example, a clock signal such as an integration start/end (exposure start/end) timing signal, a read-out control signal (horizontal scanning signal, vertical scanning signal, transmitting signal) of a light receiving signal of each pixel, and outputs the clock signal to the CCD sensor 17.

The analog signal processing circuit 32 applies a certain analog signal processing to an image signal of an analog value outputted from the CCD sensor 17. The analog signal processing circuit 32 includes a correlation double sampling (CDS) circuit for reducing a noise component which is generated during sampling of an image signal, and an automatic gain controlling (AGC) circuit for adjusting the level of an image signal. The AGC circuit has a function of compensating for insufficiency in brightness level of a photographic image in the case where an appropriate exposure is not expected with an aperture value of the diaphragm stored in the lens ROM of the lens unit 3 and with an exposure time of the CCD sensor 17 (e.g. a case of photographing an object image having an extremely low brightness). The gain of the AGC circuit is set by the main controller 90. Specifically, the analog signal processing circuit 32 performs noise reduction of an image signal by the CDS circuit, and performs brightness level adjustment of the image signal by adjusting the gain of the AGC circuit.

The A/D converting circuit 33 converts an image signal of an analog value outputted from the analog signal processing circuit 32 to an image signal of a digital value (hereinafter, referred to as “image data”) to convert a pixel signal obtained by receiving light on each pixel into pixel data of e.g. 12 bits. The A/D converting circuit 33 converts each pixel signal into pixel data (image data) of 12 bits based on a clock signal outputted from the timing controlling circuit 34 for analog-to-digital conversion.

Exposure control in the image sensing section 30 is performed by adjusting the aperture value and the exposure amount of the CCD sensor 17, namely, the charge accumulation time of the CCD sensor 17 corresponding to the shutter speed of the digital camera 1. In the case where a proper shutter speed is not settable because an object image has an extremely low brightness, exposure correction to compensate for insufficiency in exposure is performed by adjusting the output level of an image signal to be outputted from the CCD sensor 17. Specifically, exposure is controlled by combination of the shutter speed and gain adjustment when an object image has an extremely low brightness. The output level of the image signal is adjusted by adjusting the gain value of the AGC circuit in the analog signal processing circuit 32.

The timing controlling circuit 34 controls an image sensing operation of the CCD sensor 17. The timing controlling circuit 34 generates an image sensing control signal based on a control signal outputted from the main controller 90. The image sensing signal includes a control signal used for displaying a moving picture of an object image on the viewfinder display section 19 of the electronic viewfinder 4 during a photography stand-by state while the camera 1 is in recording mode (hereinafter, such an image is called as “live-view image”, and display of such a live-view image is called as “live-view display”), a control signal used for photographing a still picture of an object image (such a still picture is also called as “image for recordation”) in response to manipulation of the shutter release button 18, a reference clock signal, and a timing signal (synchronous clock signal) used for processing an image signal outputted from the CCD sensor 17 in the signal processing circuit 40. The timing signal is outputted to the analog signal processing circuit 32 and the A/D converting circuit 33.

The image memory 35 temporarily stores image data which has been converted to a digital value in the A/D converting circuit 33, and also temporarily stores image data outputted from a gamma correcting circuit 43 where gamma correction is performed. In this embodiment, the image memory 35 has such a storage capacity as to store image data corresponding to e.g. one frame of an image. In this embodiment, since the CCD sensor 17 is an area sensor having a size of 1,600 pixels (in X-direction) by 1,200 pixels (Y-direction)=1,920,000 pixels, the image memory 35 has a storage capacity of storing color pixel data of 1,920,000 pixels.

The signal processing section 40 applies a predetermined digital signal processing to an image signal outputted from the CCD sensor 17. The signal processing section 40 carries out the digital signal processing to each pixel signal constituting the image signal outputted from the CCD sensor 17. The signal processing section 40 includes a black level (BL) correcting circuit 41, a white balance (WB) adjusting circuit 42, and the gamma correcting circuit 43. The black level correcting circuit 41, the WB adjusting circuit 42, and the gamma correcting circuit 43 constitute a digital signal processing circuit of performing a digital signal processing.

After A/D conversion is performed in the A/D converting circuit 33, pixel data is temporarily stored in the image memory 35. The black level correcting circuit 41 correctively sets a black level of each pixel data which is read out from the image memory 35 to a reference black level. The WB adjusting circuit 42 adjusts a white balance of a photographic image by converting the output level of pixel data of each color component of R, G, B to an appropriate level with use of an output level conversion table outputted from the main controller 90. The conversion coefficient (gradient of a correction characteristic curve) of each color component in the output level conversion table is set with respect to each photographic image by the main controller 90.

The gamma correcting circuit 43 performs gradation correction by correcting a gamma characteristic of pixel data of each color component of R, G, B. For instance, five different kinds of correction tables each having a different gamma characteristic are prepared as a lookup table. The gamma correcting circuit 43 performs gamma correction with respect to each pixel data by referring to a relevant gamma correction table depending on the set photographic scene. By implementing the gamma correction, 10-bit pixel data is converted to 8-bit pixel data (=256 gradations). In this embodiment, pixel data before gamma correction is 10-bit pixel data to prevent image quality deterioration which is likely to occur if gamma correction is performed with a gamma characteristic curve having a strong non-linearity (namely, a gamma characteristic curve having a large gradient). It should be appreciated that the output level of pixel data of each color component of R, G, B is converted in the WB adjusting circuit 42, and gamma correction of the pixel data of each color component of R, G, B is performed with use of the relevant correction table in the gamma correcting circuit 43.

The flashlight controlling section 50 controls emission of the flash 5 based on an emission control signal outputted from the main controller 90.

The flashlight controlling section 50 includes a light adjusting circuit 51 and a light adjusting sensor 52. The emission control signal includes signals indicating designation of a flashlight preparation, a flashlight emission timing, and a flashlight amount.

The light adjusting circuit 51 controls a main capacitor to electrically charge, upon receiving a command signal indicating designation of a flashlight preparation from the main controller 90, to render the flash 5 ready for flashlight emission, and controls the main capacitor to discharge in synchronism with a flashlight timing signal outputted from the main controller 90 to cause the flash 5 to emit flashlight.

The light adjusting sensor 52 receives reflected flashlight from an object as timed with exposure start in a photographing operation with flashlight. The main controller 90 transmits a flash emission stop signal to the light adjusting circuit 51 when the light adjusting sensor 52 detects that the amount of the reflected flashlight from the object has reached a predetermined level. The light adjusting circuit 51, in response to the flash emission stop signal, causes the main capacitor to suspend discharge, whereby the flash 5 is caused to emit flashlight with an appropriate flashlight amount.

The lens controlling section 60 includes the focus motor 12 (FM in FIG. 4) for driving the focus lens, the zoom motor 13 (ZM in FIG. 4) for driving the zoom lens, and an aperture control driver 61.

The aperture control driver 61 controls an aperture value of the diaphragm which is stored in the lens ROM of the lens unit 3. As mentioned above, the aperture value is transmitted from the lens ROM to the main controller 90, and the aperture control driver 61 drives the diaphragm based on the aperture value outputted from the main controller 90, and sets the opening amount of the diaphragm in correspondence to the aperture value.

The focus motor 12 is driven based on an auto focus control signal (control value such as a drive pulse number) outputted from the main controller 90, and moves the focus lens in the lens unit 3 to a focal position.

The zoom motor 13 is driven based on a zoom control signal (operation data concerning manipulation of the four-way switch 24) outputted from the main controller 90, and moves the zoom lens in the lens unit 3 to attain a desired zooming ratio. Specifically, the zoom motor 13 moves the zoom lens to a certain direction, namely, to wide-angle (WIDE) side when operation data indicating manipulation of the rightward switch 24R of the four-way switch 24 is outputted from the main controller 90, whereas the zoom motor 13 moves the zoom lens to the opposite direction, namely, to telescopic (TELE) side when operation data indicating manipulation of the leftward switch 24L of the four-way switch 24 is outputted from the main controller 90.

The lens unit 3 is continuously shifted to WIDE side while the rightward switch 24R of the four-way switch 24 is being depressed, and is continuously shifted to TELE side while the leftward switch 24L of the four-way switch 24 is being depressed.

The display section 70 includes the viewfinder display section 19 (denoted at EVF 19 in FIG. 4) and the external display section 22 (denoted at LCD 22 in FIG. 4), as well as VRAMs 71, 72.

The VRAM 71 is a buffer memory for storing image data to be displayed on the external display section 22, and has such a storage capacity of storing color pixel data of 400 pixels (in X-direction) by 300 pixels (in Y-direction) in correspondence to the pixel number of the external display section 22. The VRAM 72 is a buffer memory for storing image data to be displayed on the viewfinder display section 19, and has such a storage capacity of storing color pixel data of 640 pixels (in X-direction) by 480 pixels (in Y-direction) in correspondence to the pixel number of the viewfinder display section 19.

In a photography stand-by state, the components 32 through 43 perform respective signal processings with respect to each pixel data of an object image sensed by the image sensing section 30 every 1/30 (sec). Thereafter, the processed data is temporarily stored in the image memory 35, transmitted to the VRAM 71 and VRAM 72 via the main controller 90, and displayed on the external display section 22 and the viewfinder display section 19, respectively (so-called “live-view display” is implemented). With this arrangement, a user can visibly recognize an object image by way of the live-view display.

Furthermore, when the memory card MC storing image data therein is mounted on the camera 1, and the camera 1 is set to reproducing mode, the main controller 90 performs a certain image processing with respect to the image data read out from the memory card MC. The processed data is transmitted to the VRAM 71 and the VRAM 72, and displayed on the external display section 22, and the viewfinder display section 19, respectively.

The operating section 80 includes the shutter release button 18 (see FIG. 3). The shutter release button 18 is a dual detectable switch in which the halfway pressed state S1 and the fully-pressed state S2 are detectable. When the shutter release button 18 is rendered to the halfway pressed state S1 in a photography stand-by state while the camera 1 is set to auto-focus photographing mode where automatic focus control is executable, the digital camera 1 is activated such that the lens motor starts to move the lens unit 3 for auto-focus control in such a way that a possible highest contrast is obtainable while allowing the main controller 90 to evaluate the contrast of the image data stored in the image memory 35, and stops the movement of the lens unit 3 when it is judged that the lens unit 3 has moved to such a position as to attain the possible highest contrast. Specifically, the main controller 90 determines the shutter speed and the aperture value by estimating the output level of the image data stored in the image memory 35 while the shutter release button 18 is in the halfway pressed state S1, and determines a correction value for white balance adjustment by the WB adjusting circuit 42. Further, while the camera 1 is in manual focus (MF) photographing mode where focusing is manually controllable by a user, the operating section 80 accepts setting of the respective control values of the shutter speed, aperture value, and ISO speed which are manually entered by the user.

The main controller 90 includes a central processing unit (CPU) having an ROM 91, an RAM 92, and an exposure controlling section 93. The ROM 91 stores a control program for controlling the operation of the CPU of the main controller 90. The RAM 92 temporarily stores various data generated by computations, control operations, and other necessary operations by the CPU. The exposure controlling section 93 judges brightness and sets an exposure amount and an ISO speed which will be effective in setting an exposure control value (shutter speed, aperture value, and ISO speed) in auto-focus photographing mode. The shutter speed, the aperture value, and the ISO speed set in the exposure controlling section 93 are temporarily stored in the RAM 92.

The main controller 90 controls respective operations of the digital camera 1 in compliance with the control program stored in the ROM 91. Specifically, the main controller 90 has a function of executing a photographing preparatory operation (preparatory operation such as setting of an exposure control value and focus adjustment) for photographing a still picture of an object image when the shutter release button 18 is set to the halfway pressed state S1, and executing an actual photographing operation (a series of operations of exposing the CCD sensor 17, implementing a predetermined image processing with respect to image signals obtained by the exposure, and recording the processed image data in the memory card MC) when the shutter release button 18 is set to the fully pressed state S2.

The main controller 90 is electrically connected with the memory card MC by a card interface board (card I/F) 36. The card I/F 36 is an interface through which image data is recordable in the memory card MC and readable out of the memory card MC.

The temperature sensor 37 detects the internal temperature of the digital camera 1. Since noise data or dark signal is varied depending on the temperature of the CCD sensor 17, it is preferable to dispose the temperature sensor 37 in vicinity of the CCD sensor 17 or the main controller 90. A real time clock 38 (RTC 38 in FIG. 4) is a timer circuit which is driven by an unillustrated power source different from the power source for driving the digital camera 1 to manage date and time of photographing.

The shutter control driver 39 controls driving of the shutter S. The shutter control driver 39 opens and closes the shutter S based on a shutter speed outputted from the main controller 90, and controls the exposure time of the CCD sensor 17.

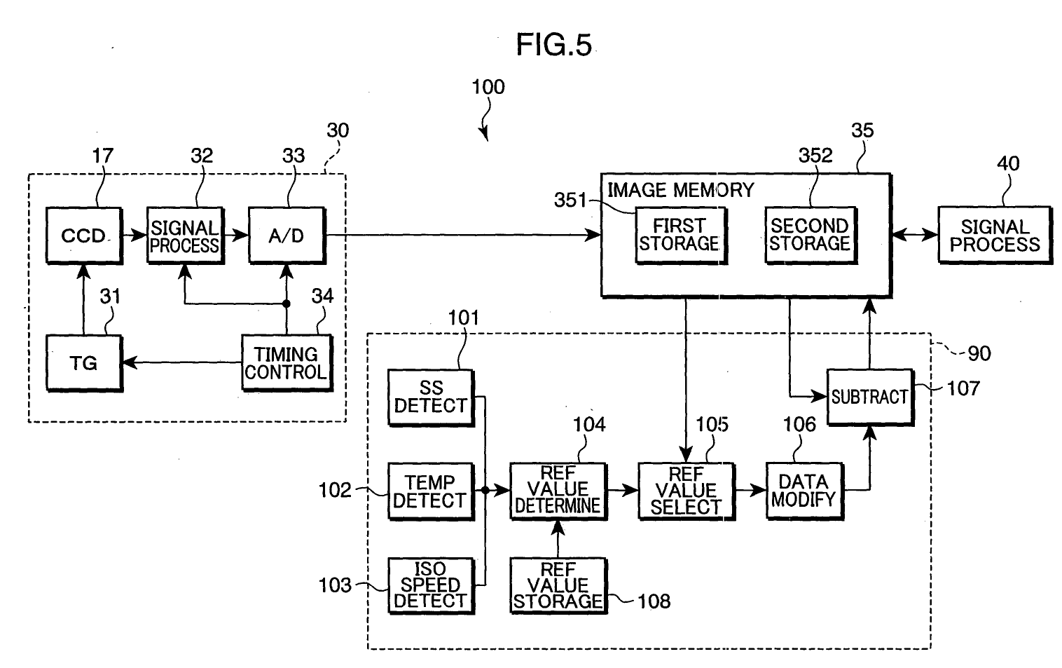

Referring to FIG. 5 showing a construction of an image sensing apparatus 100 incorporated in the digital camera 1. The image sensing apparatus 100 is comprised of the image sensing section 30, the image memory 35, the signal processing section 40, and the main controller 90.

The image memory 35 has two functions. Specifically, the image memory 35 has a first storage section 351 of storing image data outputted from the CCD sensor 17 in a first photographing operation in which photographing is carried out with an image exposure for a certain exposure time and electric charges are accumulated accordingly, and a second storage section 352 of storing noise data outputted from the CCD sensor 17 in a second photographing operation in which electric charges are accumulated with the shutter S being closed for a time duration substantially equal to the exposure time in the first photographing operation.

The main controller 90 includes a shutter speed (SS) detecting section 101, a temperature detecting section 102, an ISO speed detecting section 103, a reference value group determining section 104, a reference value selecting section 105, a data modifying section 106, a subtracting section 107, and a reference value storing section 108.

The shutter speed detecting section 101 detects the shutter speed of the camera 1. While the camera 1 is in MF photographing mode, the shutter speed detecting section 101 detects the shutter speed designated by a user by way of the operating section 80, and while the camera 1 is in AF photographing mode, the shutter speed detecting section 101 detects the shutter speed set by the exposure controlling section 93.

The temperature detecting section 102 detects the internal temperature of the digital camera 1.

The ISO speed detecting section 103 detects the ISO speed. While the camera 1 is in MF photographing mode, the ISO speed detecting section 103 detects the ISO speed designated by a user by way of the operating section 80, and while the camera 1 is in AF photographing mode, the ISO speed detecting section 103 detects the ISO speed set by the exposure controlling section 93.

The reference value group determining section 104 determines a group of reference values (hereinafter, referred to as “reference value group”) used for comparing with noise data read out from the image memory 35 based on a shutter speed detected by the shutter speed detecting section 101, an internal temperature of the camera 1 detected by the temperature detecting section 102, and an ISO speed detected by the ISO speed detecting section 103.

Specifically, the reference value group determining section 104 reads out, from the reference value storing section 108, a reference value group among a certain number of reference values groups which is prepared as table data with respect to each of reference internal temperatures T of the digital camera 1, and determines a reference value group used in selecting a reference value most approximate to the noise data, which will be explained later. Each table data stores a certain number of reference value groups in correlation with a shutter speed and an ISO speed. Note that the reference values are desirably set depending on a shutter speed, an ISO speed, and an internal temperature of the camera 1.

The reference value selecting section 105 compares the reference value group determined by the reference value group determining section 104 with the noise data read out from the image memory 35, and selects a reference value most approximate to the noise data among the reference values in the determined reference value group. The reference value selecting section 105 shifts the reference values in the reference value groups toward a higher brightness level as the shutter speed detected by the shutter speed detecting section 101 is larger (namely, the exposure time is extended), as the ISO speed detected by the ISO speed detecting section 103 increases, and as the internal temperature of the camera 1 detected by the temperature detecting section 102 rises.

In this way, the reference value storing section 108, the reference value group determining section 104, and the reference value selecting section 105 unitedly serve as a reference value setter.

The data modifying section 106 modifies the noise data read out from the image memory 35 in accordance with on the reference value selected by the reference value selecting section 105. Specifically, the reference value which is used by the data modifying section 106 is a reference value most approximate to the noise data among the reference values in the reference value group determined by the reference value group determining section 104.

The subtracting section 107 subtracts the modified noise data from the image data stored in the first storage section 351 and read out of the image memory 35.

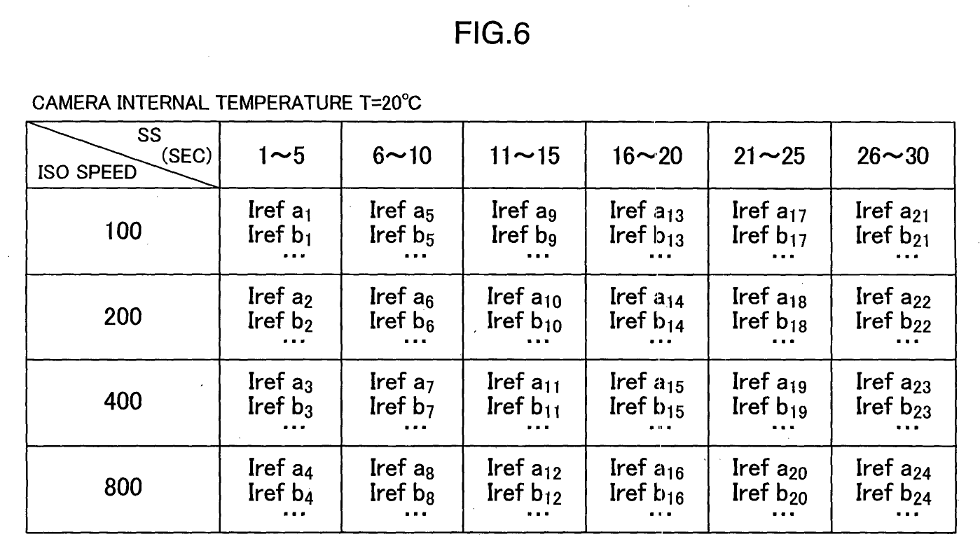

The reference value storing section 108 stores a certain number of reference value groups in correlation with the shutter speed and the ISO speed in the format of table data, wherein the table data is prepared with respect to each of reference internal temperatures T of the digital camera 1. FIG. 6 shows an exemplary table data stored in the reference value storing section 108 in the case that the reference internal temperature T of the digital camera 1 is 20° C.

Specifically, the reference value storing section 108 stores a certain number of reference value groups in correlation with the shutter speed set every predetermined time interval within a predetermined time range and the ISO speed set at a certain interval within a predetermined range as a lookup table, wherein the lookup table is prepared every predetermined temperature interval within a predetermined temperature range of the digital camera 1. In this embodiment, the reference value storing section 108 stores, for example, a lookup table every 10° C. in the temperature range of from e.g. 0° C. to 50° C. wherein each lookup table contains a certain number of reference value groups (24 reference value groups in the example of FIG. 6), the reference value groups are set in correlation with the shutter speed which is set every 5 seconds in the time range of from 1 to 30 seconds and with the ISO speed which is set at an exponential interval (e.g. 100, 200, 400, 800) in the range of from 100 to 800, and each reference value group contains a certain number of reference values (Irefa, Irefb, . . . ). Hereinafter, plural reference values in each reference value group are called as “multiple reference values”.

As shown in FIG. 6, in the case where the table corresponding to the internal temperature T=20° C. of the digital camera 1 is selected, for example, and the detected shutter speed is in the range of from 1 to 5 (sec) and the detected ISO speed is 100, then, the 1^{st} reference value group containing multiple reference values Irefa1, Irefb1, . . . is determined by the reference value group determining section 104. In the same table, if the detected shutter speed is in the range of from 26 to 30 (sec) and the detected ISO speed is 800, then, the 24^{th} reference value group containing multiple reference values Irefa24, Irefb24 is determined.

Now, multiple reference values in this embodiment are described. FIGS. 7A through 7D are illustrations explaining as to how multiple reference values in one reference value group are used for removing noise data in this embodiment. FIG. 7A shows a scan line SL relative to a sensing plane 171 of the CCD sensor 17. FIG. 7B shows noise data which is expressed in terms of multiple reference values along the axis of ordinate. FIG. 7C shows amplified noise data which is expressed in terms of multiple reference values along the axis of ordinate. FIG. 7D shows noise data which is expressed in terms of multiple reference values along the axis of ordinate in an altered case where the interval of multiple reference values in each reference value group is varied depending on the brightness level. In FIGS. 7B through 7D, the axis of ordinate represents electric current value I, and the axis of abscissas represents time. In FIGS. 7B through 7D, noise data is expressed in terms of electric current value I (brightness level) read out along the scan line SL, namely, in a horizontal direction (X-direction in FIG. 7A) relative to the image sensing plane 171 of the CCD sensor 17 in FIG. 7A.

In this embodiment, when the brightness level exceeds a predetermined value (namely, while the brightness level is in the high brightness range), the interval of multiple reference values in the reference value group determined by the reference value group determining section 104 is set at a relatively small value as compared with the case of the reference value group determined by the reference value group determining section 104 when the brightness level does not exceed the predetermined value (namely, while the brightness level is in the low brightness range). For example, the threshold value for dividing the high brightness range and the low brightness range is 0.015 A if the detected ISO speed is 100, the detected shutter speed is 4 (sec), and the reference internal temperature T is 20(° C.) based on the assumption that the maximal output current is 1A. In other words, as shown in FIG. 7B, the interval Δi of the multiple reference values in the reference value group(s) while the brightness level is higher than the threshold value Irefα is set at a smaller value than the interval Δi of the multiple reference values in the reference value group(s) while the brightness level is lower than the threshold value Irefα.

In this embodiment, in the case where the output of the noise data is increased by a rise in the internal temperature of the digital camera 1, the multiple reference values are shifted from what has been initially allocated toward a higher brightness range. Specifically, as shown in FIG. 7C, in the case where the output B of noise data is amplified to the output A, an output value corresponding to a particularly high brightness portion cannot be accurately modified in accordance with a reference value which is most approximate to the output value if the multiple reference values shown in FIG. 7B are applied as they are. As a result of such an improper conversion, the read-out noise data cannot be accurately modified in accordance with the reference value which is most approximate to the noise data. In order to solve this problem, in this embodiment, multiple reference values are shifted as a set from what has been initially allocated toward a higher brightness range if the output of noise data is increased in order to accurately find a reference value which is most approximate to the read-out noise data. In this case, it is preferable that the interval Δi of the multiple reference values in the reference value group(s) corresponding to a lower brightness portion is set at a larger value as compared with the case of FIG. 7B.

In this embodiment, the interval Δi of the multiple reference values in the reference value group(s) while the output is in the high brightness range is set at a smaller value than the interval Δi while the output is in the low brightness range in an alternative manner.

As an altered form, the interval Δi of the multiple reference values in each reference value group is decreased stepwise as the brightness level rises. In such an altered form, as shown in FIG. 7D, the interval Δi of the multiple reference values in each reference value group is decreased in proportion to the rise of the brightness level.

The multiple reference values in the reference value groups stored in the reference value storing section 108 are increased as the shutter speed is larger, as the ISO speed is increased, or as the internal temperature of the digital camera 1 rises.

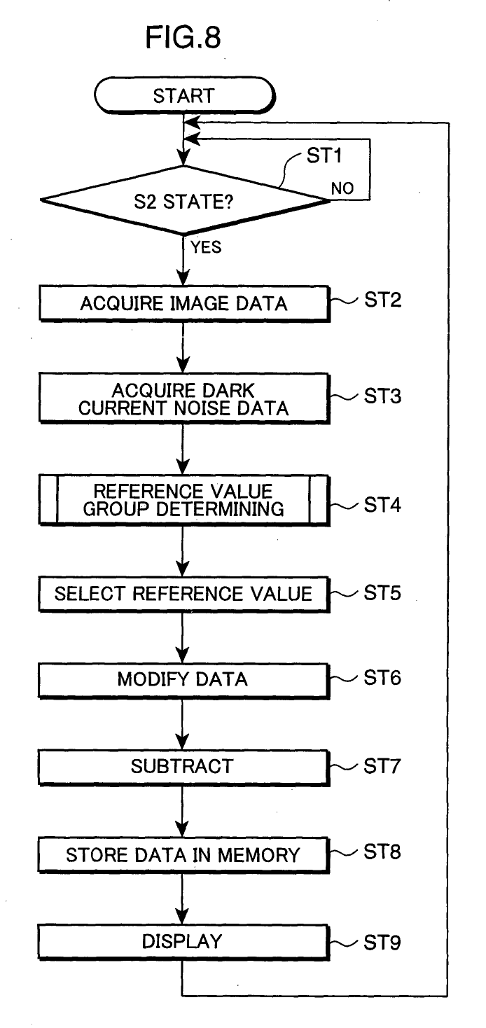

Next, the routine of removing noise data from image data in the digital camera 1 will be described with reference to a flowchart shown in FIG. 8.

Referring to FIG. 8, first, the main controller 90 judges whether the shutter release button 18 is rendered to the fully pressed state S2 in Step ST1. If there is detected an ON-signal indicating that the shutter release button 18 is brought to the fully pressed state S2 (YES in Step ST1), the routine proceeds to Step ST2. On the other hand, if there is not detected the ON-signal (NO in Step ST1), the camera 1 is brought to a photography stand-by state.

In Step ST2, the main controller 90 controls the camera 1 to perform the first photographing operation of exposing an object image in response to a user's manipulation of rendering the shutter release button 18 to the fully pressed state S2. In the first photographing operation, the CCD sensor 17 photoelectrically converts the optical energy from the object image focused on the image sensing plane 171 of the CCD sensor 17 by way of the lens unit 3 to electrical signals, and outputs pixel data corresponding to the sensed image to the signal processing circuit 32. The pixel data is then converted into digital signals by the signal processing circuit 32 and the A/D converting circuit 33, and is stored in the first storage section 351 of the image memory 35, and the routine goes to Step ST3.

In Step ST3, the main controller 90 controls the camera 1 to perform the second photographing operation of accumulating electric charges for a time duration substantially equal to the exposure time in the first photographing operation with the shutter S being closed or in a light-blocked state. In the second photographing operation, the CCD sensor 17 outputs pixel data obtained by photoelectrical conversion in the light-blocked state to the signal processing circuit 32. The pixel data is then converted into digital signals by the signal processing circuit 32 and the A/D converting circuit 33, and is stored in the second storage section 352 of the image memory 35 as noise data, and the routine goes to Step ST4.

In Step ST4, the reference value group determining section 104 implements a reference value group determining operation of determining a reference value group used for noise data removal based on a shutter speed detected by the shutter speed detecting section 101, a temperature detected by the temperature detecting section 102, and an ISO speed detected by the ISO speed detecting section 103. The reference value group determining operation will be described with reference to FIG. 10. After Step ST4, the routine goes to Step ST5.

In Step ST5, the reference value selecting section 105 compares the noise data stored in the second storage section 352 of the image memory 35 with the reference value group determined by the reference value group determining section 104. In this step, the reference value selecting section 105 searches for a reference value among the multiple reference values of the determined reference value group which is most approximate to the electric current value I corresponding to the noise data, and sets the reference value as a value to be processed in the data modifying section 106. The reference value selected by the reference value selecting section 105 is outputted to the data modifying section 106, and the routine goes to Step ST6.

In Step ST6, the data modifying section 106 modifies the noise data stored in the second storage section 352 and read out from the image memory 35 in accordance with the reference value selected by the reference value selecting section 105, namely with the electric current value I corresponding to the selected reference value.

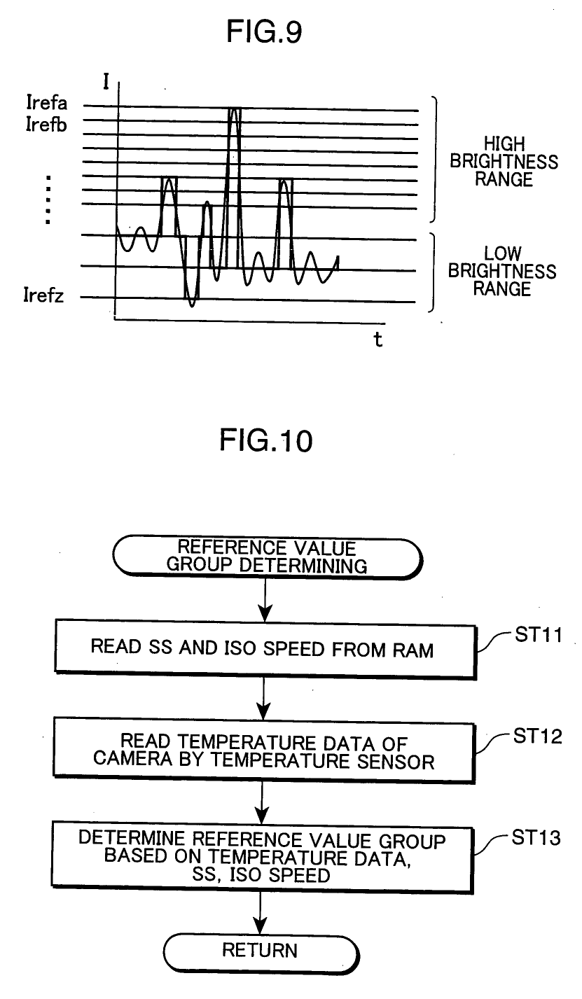

Referring to FIG. 9 showing how noise data is modified by data modification in Step ST6. In FIG. 9, the axis of ordinate represents electric current value, and the axis of abscissas represents time. In FIG. 9, noise data is expressed in terms of electric current value I (brightness level) read out along the scan line SL in the horizontal direction (X-direction in FIG. 7A) relative to the sensing plane 171 of the CCD sensor 17 shown in FIG. 7A. As shown in FIG. 9, since a noise component in the low brightness range is modified in accordance with a reference value which is most approximate to the noise data, this technique can securely remove random noise components other than offset noise components.

Referring back to FIG. 8, after Step ST6, the routine goes to Step ST7. In Step ST7, the subtracting section 107 subtracts the modified noise data, which has been modified in accordance with the reference value most approximate to the read-out noise data by the data modifying section 106, from the image data stored in the first storage section 351 of the image memory 35 and read out from the image memory 35, and outputs the image data with noise components being removed to the image memory 35, and the routine goes to Step ST8.

In Step ST8, the image memory 35 stores the image data with the noise component being removed, and the routine goes to Step ST9.

In Step ST9, the signal processing section 40 performs various signal processings with respect to the image data stored in the image memory 35 after the noise data are removed, and outputs the processed image data to the display section 70 to display an image thereon.

FIG. 10 shows a reference value group determining subroutine performed in Step ST4 of the routine shown in FIG. 8. In Step ST11, the shutter speed detecting section 101 detects a shutter speed by reading out the shutter speed stored in the RAM 92 of the main controller 90, and the ISO speed detecting section 103 detects an ISO speed by reading out the ISO speed stored in the RAM 92 of the main controller 90. The shutter speed detected by the shutter speed detecting section 101 and the ISO speed detected by the ISO speed detecting section 103 are outputted to the reference value group determining section 104, and the subroutine goes to Step ST12.

In Step ST12, the temperature detecting section 102 detects the internal temperature of the digital camera 1 with use of the temperature sensor 37. The temperature data detected by the temperature detecting section 102 is outputted to the reference value group determining section 104, and this subroutine goes to Step ST13.

In Step ST13, the reference value group determining section 104 determines the reference value group used for noise data removal based on the shutter speed detected by the shutter speed detecting section 101, the temperature detected by the temperature detecting section 102, and the ISO speed detected by the ISO speed detecting section 103 while referring to relevant table data stored in the reference value storing section 108.

In this way, stored in the first storage section 351 is image data outputted from the CCD sensor 17 in the first photographing operation in which an object image is exposed and accordingly electric charges are accumulated by the image exposure, whereas stored in the second storage section 352 is noise data outputted from the image sensing section 30 in the second photographing operation in which electric charges are accumulated for a time duration substantially equal to the exposure time in the first photographing operation in the light blocking state. Then, the reference value selecting section 105 compares noise data stored in the second storage section 352 with the reference value group determined by the reference value group determining section 104, and selects the reference value which is most approximate to the noise data among the multiple reference values in the relevant reference value group. The data modifying section 106 modifies the noise data stored in the second storage section 352 in accordance with the reference value selected by the reference value selecting section 105. The subtracting section 107 subtracts the modified noise data from the image data stored in the first storage section 351, and the image data with the noise data having been removed is stored in the image memory 351.

In the above arrangement, noise data having a relatively large peak can be removed, and random noise components and FPNs generated at a low brightness level can be modified in accordance with an appropriate reference value. Accordingly, S/N ratio of a sensed image is improved, and high quality image is obtained, which could not been accomplished according to the prior art of simply subtracting dark current noise data from image data.

In the above arrangement, multiple reference values are set for use in comparison with noise data stored in the second storage section 352 based on the shutter speed detected by the shutter speed detecting section 101, the internal temperature of the digital camera 1 detected by the temperature detecting section 102, and the ISO speed detected by the ISO speed detecting section 103. Accordingly, even if the photographing conditions such as the shutter speed, the ISO speed, and the internal temperature of the camera are changed, appropriate noise removal operation can be implemented depending on the photographing conditions.

Furthermore, the multiple reference values stored in the reference value storing section 108 are set such that the multiple reference values as a whole are shifted from what has been initially allocated toward a higher brightness range to follow up an increase in the shutter speed, increase in the ISO speed, and rise in the internal temperature of the camera 1. Accordingly, the multiple reference values as a whole can be shifted from what has been initially allocated toward a higher brightness range when the detected shutter speed is increased, the detected ISO speed is increased, or the detected internal temperature of the camera 1 rises.

Generally, noise become remarkably large as the shutter speed is increased, the ISO speed is increased, and the internal temperature of the camera 1 rises. This embodiment can perform noise removal operation to cope with such change of the photographing conditions.

In this embodiment, the reference value storing section 108 stores a certain number of reference value groups with respect to each of the reference internal temperatures T of the camera 1 in the format of lookup tables, and each reference value group is set in correlation with the shutter speed and the ISO speed.

Alternatively, a reference value group depending solely on the internal temperature of the camera 1 may be stored, or a reference value group depending solely on the shutter speed may be stored, or a reference value group depending solely on the ISO speed may be stored. In other words, a reference value group may be stored in association with at least one of the internal temperature of the camera 1, the shutter speed, and the ISO speed.

In this embodiment, the multiple reference values in the reference value groups stored in the reference value storing section 108 are increased if at least one of the shutter speed, the ISO speed, and the internal temperature of the camera 1 rises.

Alternatively, the multiple reference values may be increased if all of the shutter speed increases, the ISO speed, and the internal temperature of the camera 1 rise.

As yet another altered form, the multiple reference values may be increased if at least two of the shutter speed, the ISO speed, the internal temperature of the camera 1 rise.

In case of employing a cooled CCD which is not easily affected by heat, for example, the reference value storing section 108 may store multiple reference values which have correlation solely to the shutter speed and the ISO speed in the format of table data.

In this embodiment, the second storage section 352 stores noise data outputted from the image sensing section 30 in the second photographing operation in which electric charges are accumulated for a time duration substantially equal to the exposure time in the first photographing operation with the shutter S being closed. However, a light blocking member for blocking the CCD sensor 17 from light may be provided between the lens unit 3 and the CCD sensor 17, and the second storage section 352 may store noise data outputted from the image sensing section 30 in the second photographing operation in which electric charges are accumulated for a time duration substantially equal to the exposure time in the first photographing operation in a state that the CCD sensor 17 is blocked from light by the light blocking member.

Next, another embodiment of the present invention will be described. As described above, noises become remarkably large as the shutter speed is increased or the exposure time becomes long. This means that photographing is enabled without considering noise data if the shutter speed is sufficiently fast or the exposure time is sufficiently short. In view of this, in this embodiment, judgment is made as to whether noise removal is to be executed depending on the shutter speed.

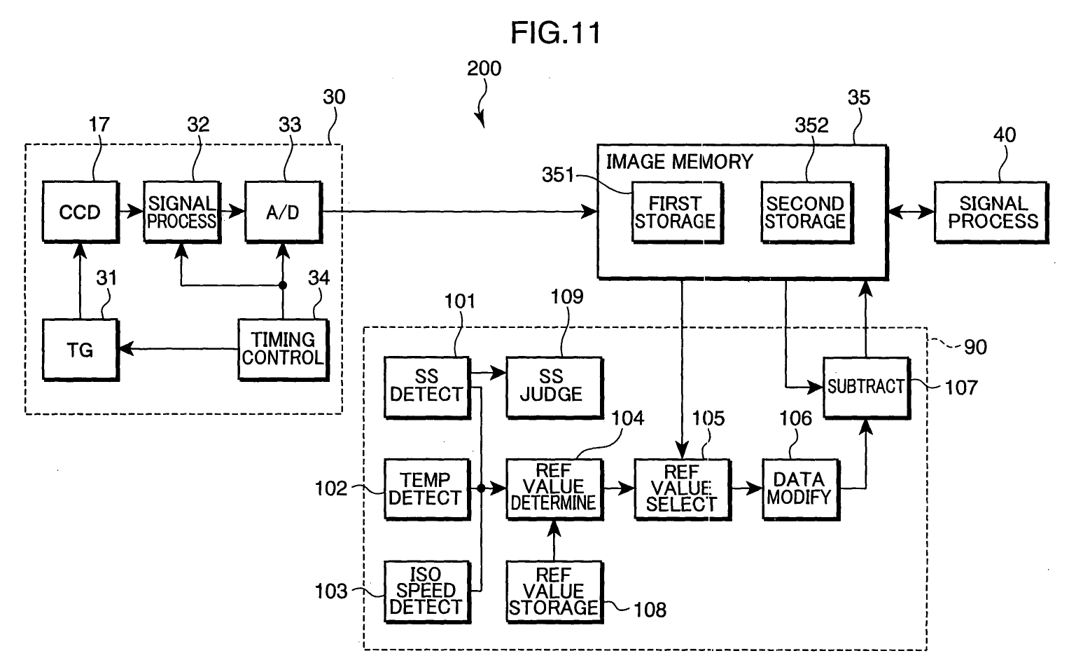

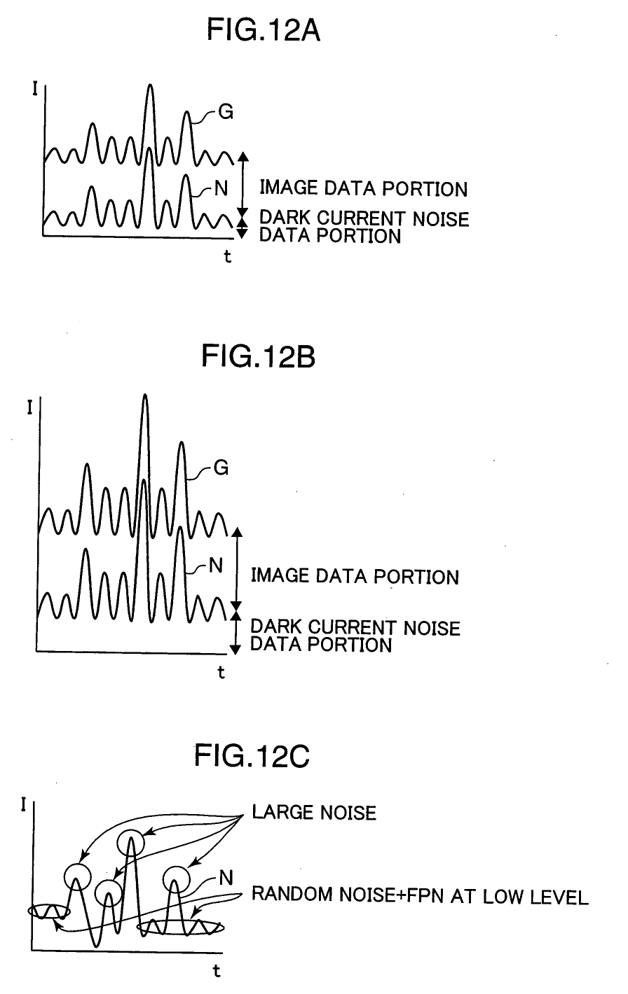

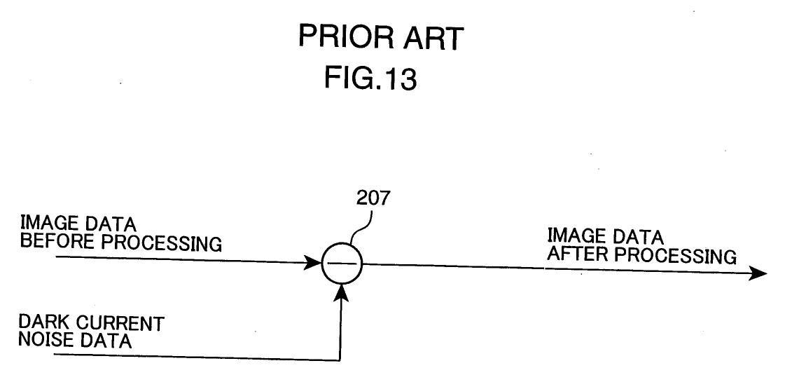

FIG. 11 is a block diagram showing a construction of an image sensing apparatus 200 in accordance with the second embodiment of the invention. The image sensing apparatus 200 is comprised of an image sensing section 30, an image memory 35, an image processing section 40, and a main controller 90.

The main controller 90 includes a shutter speed (SS) detecting section 101, a temperature detecting section 102, an ISO speed detecting section 103, a reference value group determining section 104, a reference value selecting section 105, a data modifying section 106, a subtracting section 107, a reference value storing section 108, and a shutter speed judging section 109. Since the image sensing apparatus 200 has basically the construction identical to the image sensing apparatus 100 in the first embodiment shown in FIG. 5, merely different elements in the second embodiment from those in the first embodiment will be described in the following section.

The shutter speed judging section 109 judges whether noise data removal operation is required to be executed based on a shutter speed detected by the shutter speed detecting section 101.

The shutter speed judging section 109 performs the judgment based on whether a shutter speed detected by the shutter speed detecting section 101 exceeds a predetermined value. If the detection result exceeds the predetermined value, noise removal is required, whereas the detection result does not exceed the predetermined value, noise removal is not required because the output from the image sensing apparatus 200 is free from an affect of noise components while the detection result lies below the predetermined value. Specifically, if it is judged that the shutter speed detected by the shutter speed detecting section 101 exceeds the predetermined value, noise removal is executed. On the other hand, if it is judged that the shutter speed detected by the shutter speed detecting section 101 does not exceed the predetermined value, image data outputted from the CCD sensor 17 obtained by charge accumulation in the first photographing operation with image exposure is stored in the image memory 35 without executing noise removal operation. The image data stored in the image memory 35 is then applied with various signal processings in the similar manner as in the first embodiment, and the processed image is displayed on a display section 70.

Next, the operation of the image sensing apparatus 200 is described referring to FIG. 8. In the second embodiment, after implementing the operation in Step ST2 in FIG. 8, the shutter speed judging section 109 judges whether the shutter speed detected by the shutter speed detecting section 101 is not shorter than one second. If it is judged that the detection result is not shorter than one second, the routine implements the operations from Step ST3 to Step ST8. On the other hand, if the detection result is shorter than one second, the routine goes to Step ST9, while skipping steps ST2 through ST8.

In this way, if the shutter speed judging section 109 judges that the detection result is not shorter than the predetermined value (in this embodiment, one second), stored in a second storage section 352 is noise data outputted from the CCD sensor 17 in the second photographing operation in which electric charges are accumulated for a time duration substantially equal to the exposure time in the first photographing operation with the shutter S being closed. In other words, generally, while the shutter speed is fast or the exposure time is short, the camera is less likely to be affected by noise components. Accordingly, noise removal operation can be omitted while the shutter speed is fast, which makes it possible to simplify the operation for the camera.

In the second embodiment, in the case where the shutter speed judging section 109 judges that the shutter speed detected by the shutter speed detecting section 101 is not shorter than the predetermined value (in this embodiment, one second), stored in the second storage section 352 is noise data outputted from the CCD sensor 17 in the second photographing operation of accumulating electric charges for a time duration substantially equal to the exposure time in the first photographing operation. Alternatively, a light blocking member may be provided between a lens unit 3 and the CCD sensor 17 to block the CCD sensor 17 from light, and if the shutter speed judging section 109 judges that the detected shutter speed is not shorter than the predetermined value (in this embodiment, one second), stored in the second storage section 352 is noise data outputted from the CCD sensor 17 in the second photographing operation of accumulating electric charges for a time duration substantially equal to the exposure time in the first photographing operation with the CCD sensor 17 being blocked from light by the light blocking member.

As described above, an inventive image sensing apparatus is provided with an image sensor for generating electric charges in accordance with an exposure to an object; a first storage section for storing image data outputted from the image sensor in a first photographing operation of accumulating electric charges in accordance with an exposure to an object for a specified exposure time; a second storage section for storing noise data outputted from the image sensor in a second photographing operation of accumulating electric charges without exposure for a time substantially equal to the exposure time in the first photographing operation; a multiple reference value storing section for storing multiple reference values for modifying noise data; a reference value selecting section for comparing noise data stored in the second storage section with multiple reference values stored in the multiple reference value storing section, and selecting a reference value among the multiple reference values which is most approximate to the noise data; a data modifying section for modifying the noise data in accordance with the selected reference value; and a subtracting section for subtracting the modified noise data from the image data stored in the first storage section.

The image sensing apparatus may be preferably further provided with at least one of an exposure time detecting section for detecting an exposure time of the image sensing apparatus, a photographic sensitivity detecting section for detecting a photographic sensitivity of the image sensing apparatus, and a temperature detecting section for detecting an internal temperature of the image sensing apparatus; a reference value storing section for storing a plurality of reference value groups each having multiple reference values, the plurality of reference value groups in correlation with at least one of the exposure time, the photographic sensitivity, and the internal temperature of the image sensing apparatus; and a reference value group determining section for determining a reference value group among the plurality of reference value groups based on a detection from at least one of the exposure time detecting section, the photographic sensitivity detecting section, and the temperature detecting section. The reference value selecting section compares the noise data stored in the second storage section with multiple reference values in a reference value group determined by the reference value group determining section.

The interval between multiple reference values for noise data having a higher brightness level may be preferably smaller than the interval between multiple reference values for noise data having a lower brightness level. The interval between multiple reference values may preferably become smaller as the brightness level rises.

The multiple reference values may be preferably set based on a detection from at least one of the exposure time detecting section, the photographic sensitivity detecting section, and the temperature detecting section.

The multiple reference values may be preferably set so as to raise the brightness level as the exposure time is increased. The multiple reference values may be preferably set so as to raise the brightness level as the photographic sensitivity is increased. The multiple reference values may be preferably set so as to raise the brightness level as the internal temperature of the image sensing apparatus rises.

Also, an inventive exposure signal processing apparatus comprises a first sensing controller for accumulating electric charges in accordance with an exposure having a specified exposure time to generate an exposure signal; a second sensing controller for accumulating electric charges without exposure for a time substantially equal to the exposure time of the first sensing controller to generate a dark signal; a modifier for modifying the dark signal; and a corrector for correcting the exposure signal based on modified dark signal.

The second sensing controller may preferably accumulate electric charges immediately after the first sensing controller completes the accumulation of electric charges.

It may be preferable that the first sensing controller executes the accumulation of electric charges owing to an exposure to light from an object, and the second sensing controller executes the accumulation of electric charges without an exposure to light from an object.

The modifier modifies the dark signal in consideration of a noise component.

The exposure signal processing apparatus may be preferably further provided with a modification reference value selector including a storage section for storing a plurality of modification reference values for selecting one among the plurality of modification reference values by comparing the dark signal with the plurality of modification reference values. The selector selects a modification reference value which is most approximate to the dark signal from the second sensing controller. The modifier modifies the dark signal in accordance with the selected modification reference value. The selector selects a modification reference value among the plurality of modification reference values based on a brightness level obtained from the exposure signal from the first sensing controller.

The interval between the plurality of modification reference values may preferably become smaller as the brightness level rises.

The exposure signal processing apparatus may be further provided with a detector which detects an exposure time of the first sensing controller. The modifier executes the dark signal modification when the exposure time is larger than a predetermined value.

Further, an inventive method for removing noise data in an image sensing apparatus having an image sensor, comprising the steps of: storing image data outputted from the image sensor by exposing the image sensor to an object for an exposure time; storing noise data outputted from the image sensor by operating the image sensor without exposure to an object for a time substantially equal to the exposure time; comparing the stored noise data with multiple reference values to select a reference value among the multiple reference values which is most approximate to the noise data; modifying the noise data in accordance with the selected reference value; and subtracting the modified noise data from the image data stored in the first storage section.

With these constructions, a high quality image can be obtained as compared with the conventional arrangement of merely subtracting dark current noise data from image data because a variety of noise data, such as random noises at a low brightness level, can be eliminated accurately in accordance with operation conditions.

As the invention may be embodied in several forms without departing from the spirit of essential characteristics thereof, the present embodiment is therefore illustrative an not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image sensing apparatus comprising:
an image sensor which is operable to generate electric charges in accordance with an exposure to an object;
a first storage section which stores image data outputted from the image sensor in a first photographing operation of accumulating electric charges in accordance with an exposure to an object for a specified exposure time;
a second storage section which stores noise data outputted from the image sensor in a second photographing operation of accumulating electric charges without exposure for a time substantially equal to the exposure time in the first photographing operation;
a multiple reference value storing section which stores multiple reference values for modifying noise data;
a reference value selecting section which compares the noise data stored in the second storage section with the multiple reference values stored in the multiple reference value storing section, and selects a reference value among the multiple reference values which is most approximate to the noise data;
a data modifying section which modifies the noise data in accordance with the selected reference value; and
a subtracting section which subtracts the modified noise data from the image data stored in the first storage section.

2. The image sensing apparatus according to claim 1, further comprising:
at least one of an exposure time detecting section which detects an exposure time of the image sensing apparatus, a photographic sensitivity detecting section which detects a photographic sensitivity of the image sensing apparatus, and a temperature detecting section which detects an internal temperature of the image sensing apparatus;
a reference value storing section which stores a plurality of reference value groups each having multiple reference values, the plurality of reference value groups in correlation with at least one of the exposure time, the photographic sensitivity, and the internal temperature of the image sensing apparatus; and
a reference value group determining section which determines a reference value group among the plurality of reference value groups based on a detection from at least one of the exposure time detecting section, the photographic sensitivity detecting section, and the temperature detecting section;
wherein the reference value selecting section compares the noise data stored in the second storage section with multiple reference values in a reference value group determined by the reference value group determining section.

3. The image sensing apparatus according to claim 1, wherein the interval between multiple reference values for noise data having a higher brightness level is smaller than the interval between multiple reference values for noise data having a lower brightness level.

4. The image sensing apparatus according to claim 1, wherein the interval between multiple reference values becomes smaller as the brightness level rises.

5. The image sensing apparatus according to claim 1, further comprising at least one of an exposure time detecting section which detects an exposure time of the image sensing apparatus, a photographic sensitivity detecting section which detects a photographic sensitivity of the image sensing apparatus, and a temperature detecting section which detects an internal temperature of the image sensing apparatus, wherein multiple reference values are set based on a detection from at least one of the exposure time detecting section, the photographic sensitivity detecting section, and the temperature detecting section.

6. The image sensing apparatus according to claim 1, wherein the multiple reference values are set so as to raise the brightness level as the exposure time is increased.

7. The image sensing apparatus according to claim 1, wherein the multiple reference values are set so as to raise the brightness level as the photographic sensitivity is increased.

8. The image sensing apparatus according to claim 1, wherein the multiple reference values are set so as to raise the brightness level as the internal temperature of the image sensing apparatus rises.

9. An exposure signal processing apparatus comprising:
a first sensing controller which accumulates electric charges in accordance with an exposure having a specified exposure time to generate an exposure signal;
a second sensing controller which accumulates electric charges without exposure for a time substantially equal to the exposure time of the first sensing controller to generate a dark signal;
a modifier which modifies the dark signal; and
a corrector which corrects the exposure signal based on the modified dark signal.

10. The exposure signal processing apparatus according to claim 9, wherein the second sensing controller accumulates electric charges immediately after the first sensing controller completes the accumulation of electric charges.

11. The exposure signal processing apparatus according to claim 9, wherein the first sensing controller executes the accumulation of electric charges owing to an exposure to light from an object, and the second sensing controller executes the accumulation of electric charges without an exposure to light from an object.

12. The exposure signal processing apparatus according to claim 9, wherein the modifier modifies the dark signal in consideration of a noise component.

13. The exposure signal processing apparatus according to claim 9, further comprising a modification reference value selector which includes a storage section for storing a plurality of modification reference values, and selects one among the plurality of modification reference values by comparing the dark signal with the plurality of modification reference values.

14. The exposure signal processing apparatus according to claim 13, wherein the selector selects a modification reference value which is most approximate to the dark signal from the second sensing controller.

15. The exposure signal processing apparatus according to claim 14, wherein the modifier modifies the dark signal in accordance with the selected modification reference value.

16. The exposure signal processing apparatus according to claim 13, wherein the selector selects a modification reference value among the plurality of modification reference values based on a brightness level obtained from the exposure signal from the first sensing controller.

17. The exposure signal processing apparatus according to claim 16, wherein the interval between the plurality of modification reference values becomes smaller as the brightness level rises.

18. The exposure signal processing apparatus according to claim 9, further comprising a detector which detects an exposure time of the first sensing controller, wherein the modifier executes the dark signal modification when the exposure time is larger than a predetermined value.

19. A method for removing noise data in an image sensing apparatus having an image sensor, comprising the steps of:
storing image data outputted from the image sensor by exposing the image sensor to an object for an exposure time;
storing noise data outputted from the image sensor by operating the image sensor without exposure to an object for a time substantially equal to the exposure time;
comparing the stored noise data with multiple reference values to select a reference value among the multiple reference values which is most approximate to the noise data;
modifying the noise data in accordance with the selected reference value; and
subtracting the modified noise data from the image data stored in the first storage section.
